(19) United States
(12) Patent Application Publication
(10) Pub. No.: US 2025/0289962 A1
(43) Pub. Date: Sep. 18, 2025

(54) WEATHERABLE POWDER COATING PRIMER COMPOSITION INCLUDING ZINC

(71) Applicant: PPG INDUSTRIES OHIO, INC., Cleveland, OH (US)

(72) Inventors: Travis Owen Bush, Valley View, TX (US); Paul William Bradley, Corinth, TX (US); Victor Alfonso Monroy, Whitesboro, TX (US)

(73) Assignee: PPG INDUSTRIES OHIO, INC., Cleveland, OH (US)

(21) Appl. No.: 18/860,118

(22) PCT Filed: Apr. 19, 2023
(86) PCT No.: PCT/US2023/065931

§ 371 Date: Oct. 25, 2024

Related U.S. Application Data
(60) Provisional application No. 63/364,224, filed on May 5, 2022.

(51) Int. Cl. C09D 5/10; C08K 3/04; C08K 7/00; C09D 7/40; C09D 7/61; C09D 163/00; C09D 167/00; C09D 175/06

(52) U.S. Cl. CPC C09D 5/106; C09D 7/61; C09D 7/70; C09D 163/00; C09D 167/00; C09D 175/06; C08K 3/041; C08K 7/00; C08K 2201/011

(57) ABSTRACT

Zinc containing, or zinc rich powder coating compositions and methods of using the compositions, making the compositions, and applying the compositions to a substrate. The coating compositions may also comprise a film forming resin, and a cross linker. Substrates may be coated by contacting a least a portion of the substrate with the coating composition and curing the composition to form a coating layer. The coating provides a durable weather resistant layer to the substrates and reduces the potential for delamination of topcoats.

### CROSS REFERENCE TO RELATED APPLICATION

This application claims the benefit under 35 U.S.C. § 119(e) of U.S. Provisional Application No. 63/364,224, filed on May 5, 2022, which is incorporated by reference in its entirety.

### FIELD

The present disclosure relates to zinc-containing, or zinc rich powder coating primer compositions for improving the weatherability of corrosion sensitive substrates, and methods for making and using the same.

### BACKGROUND

Galvanization is one conventional method of providing durability and weathering protection to metal substrates, including steel substrates such as guardrails, transmission towers, electrical equipment, building materials, and dozens of other specific applications because it provides a means for the long-term protection of steel from oxidation and subsequent corrosion. 125 microns of a galvanizing composition is sufficient to protect exposed equipment for a period of at least 20 years. These galvanizing compositions may be applied both by hot dipping and electroplating.

Similarly, powder coatings are applied to metal substrates, such as steel substrates, to provide numerous beneficial properties including corrosion protection and/or decoration. Powder coatings typically comprise an extruded thermoplastic or thermoset polymer which is then ground or milled into a powder. The powder is then typically electrostatically applied to a substrate, and then cured with heat or UV radiation to form a coating layer. Zinc containing, or zinc rich powder coatings typically include an inorganic binder that facilitates an even coating or the powder coating on the surface of a given substrate. The resultant coatings create a bonding matrix which allows a controlled galvanic current flow between the ferrous substrate and the zinc rich coating.

### SUMMARY

The present disclosure provides zinc containing, or zinc rich powder coating compositions and methods of using the compositions, making the compositions, and/or applying the compositions to a substrate. The coating compositions may also comprise a film forming resin, and a cross linker. Substrates may be coated by contacting a least a portion of the substrate with the coating composition and curing the composition to form a coating layer. The coating provides a durable weather resistant layer to the substrate and reduces the potential for delamination of topcoats.

In one form thereof, the present disclosure provides a powder coating composition including zinc metal in an amount of from 20 wt. % to 50 wt. % based on a total weight of the powder coating composition and a film forming resin in an amount from 35 wt. % to 80 wt. % based on a total weight of the coating composition, with the zinc metal present in at least two physical forms.

In a second form thereof, the present disclosure provides a substrate coated with the powder coating composition as described herein. The substrate's coating has a surface resistivity of from 100 to 10,000,000 ohms/sq. and/or less than 3 mm scribe creepage after 3000 hours of salt spray according to ASTM D 1654-08.

### BRIEF DESCRIPTION OF THE DRAWINGS

FIG. 1 illustrates a schematic, cross sectional view of a powder coating stackup as described in the present disclosure.

### DETAILED DESCRIPTION

Currently, zinc rich epoxy powder coating primers are used in corrosive environments over steel substrates with various exterior durable powder coating topcoats. If the topcoat is transparent to ultraviolet light, there is a potential for degradation of these zinc rich epoxy primers resulting in delamination of the exterior durable powder coating topcoat. Ideally, the primer is exterior durable which would eliminate the potential for the delamination of the topcoat. Solving this problem may eliminate or greatly minimize the risk of topcoat delamination on exterior substrates that are exposed to weather. The present disclosure addresses this and other needs.

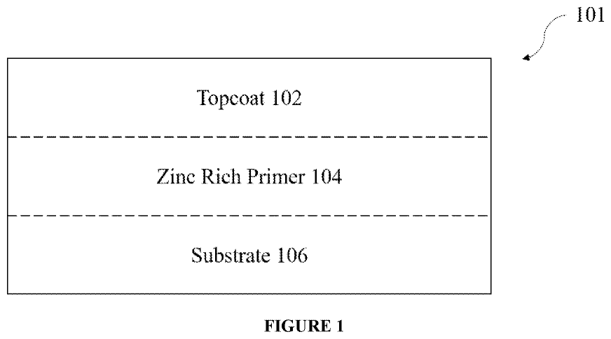

As shown in FIG. 1, a stackup 101 of the powder coating atop a substrate 106 is shown. The primer 104 may be applied to the substrate 106 by any suitable method before topcoat 102 is applied atop the primer layer. The exterior durability of the primer layer 104 strengthens the bond between primer layer 104 and topcoat layer 102, greatly reducing the risk of topcoat delamination.

### I. Definitions:

For purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polymer, “a” pigment, and the like refer to one or more of any of these items.

“Polymer” refers to oligomers, homopolymers (e.g. prepared form a single monomer species), copolymers (e.g. prepared form at least two monomer species), terpolymers (e.g. prepared from at least three monomer species), and graft polymers.

“Film forming resin” refers to a resin that may form a self-supporting continuous film on at least a horizontal surface of a substrate upon removal or any diluents or carriers.

“Crosslinker” refers to a molecule comprising two or more functional groups that are reactive with other functional groups and that is capable of linking two or more monomers or polymers through chemical bonds.

### II. Powder Coating Compositions

The powder coating compositions as described herein generally comprise a film forming resin, a cross linker, and zinc metal. The powder coating compositions may also comprise other additives such as flow agents, colorants, stabilizers, degassing agents, antioxidants, hardening agents, waxes, and the like. The coating compositions may be applied and cured to form a coating layer on a variety of metallic and non-metallic substrates to improve their weatherability.

The coating compositions may be layered underneath a powder overcoat which, as used herein, refers to an overcoat embodied in solid particulate form. The coating compositions may also be layered over top of a powder basecoat which, as used herein, refers to a basecoat embodied in solid particulate form. The coating composition may also be layered underneath or above a liquid overcoat, which may be formed by melting or otherwise liquidizing a powder overcoat. Multiple layers of coating compositions may be used to form multi-layer coatings. The coating compositions may be layered underneath a topcoat or series of topcoats, or above a base coat or series of base coats to form a stackup.

### III. Resins

The coating compositions herein may comprise a binder or a film forming resin in one or multiple components. Further, a “binder” refers to a constituent material that may hold all coating composition components together upon curing. The binder may comprise one or more film-forming resins that may be used to form the coating layer. As used herein, a “film-forming resin” refers to a resin that may form a self-supporting continuous film on at least a horizontal surface of a substrate upon removal or any diluents or carriers present in the composition and/or upon curing. The term “resin” is used here interchangeably with “polymer”. Film forming resins may be incorporated into components of the powder coating compositions as a liquid or as a solid.

The coating composition used with the present disclosure may include any variety of thermosetting powder compositions as known in the art. As used herein, the term “thermosetting” refers to compositions that “set” irreversibly upon curing or crosslinking, wherein polymer chains of polymeric components are joined together by covalent bonds. This property is usually associated with a cross-linking reaction of the composition constituents often induced, for example, by heat or radiation. Once cured, a thermosetting resin will not melt upon the application of heat and is insoluble in solvents. The coating compositions used with the present disclosure may also include thermoplastic powder compositions. As used herein, “thermoplastic” refers to compositions that include polymeric components that are not joined by covalent bonds and, thereby, can undergo liquid flow upon heating.

Suitable film-forming resins include (meth)acrylate resins, polyurethanes, polyesters, polyamides, polyethers, polysiloxanes, epoxy resins, vinyl resins, copolymers thereof, and combinations thereof. As used herein, “(meth)acrylate” and like terms refers both to the acrylate and the corresponding methacrylate. Further, the film-forming resins may have any of a variety of functional groups including, but not limited to, carboxylic acid groups, amine groups, epoxide groups, hydroxyl groups, thiol groups, carbamate groups, amide groups, urea groups, isocyanate groups (including blocked isocyanate groups), and combinations thereof.

The coating compositions may comprise any number of film forming resins, such as one film forming resin, or two or more film forming resins. Any particular film forming resin or any combination of form filming resins may be present in the coating composition in an amount of as little as 20 wt. %, 25 wt. %, 30 wt. %, 35 wt. %, 40 wt. %, 45 wt. %, 50 wt. %, 55 wt. % or in an amount as great as 95 wt. % 90 wt. %, 85 wt. %, 80 wt. %, 75 wt. %, 70 wt. %, 65 wt. %, 60 wt. %, or any range including any two of these values as endpoints based on the total weight of the coating composition. Any particular film forming resin or combination of film forming resins may be present in the coating composition from 40 wt. % to 90 wt. %, from 40 wt. % to 85 wt. %, from 45 wt. % to 80 wt. %, from 50 wt. % to 80 wt. %, from 55 wt. % to 80 wt. %, from 55 wt. % to 75 wt. %, or from 60 wt. % to 70 wt. % based on the total weight of the coating composition or based on the weight of one component of the coating composition.

### IV. Crosslinkers

The coating compositions of the present disclosure may comprise a crosslinker in one or multiple components that may be selected from any of the crosslinkers known in the art to react with the functionality of one or more film-forming resins used in the coating composition. As used herein, the term “crosslinker” refers to a molecule comprising two or more functional groups that are reactive with other functional groups and that is capable of linking two or more monomers or polymers through chemical bonds. Alternatively, the film-forming resins that form the binder of the coating composition may have functional groups that are reactive with themselves; in this manner, such resins are self-crosslinking.

Suitable crosslinkers include phenolic resins, amino resins, epoxy resins, triglycidyl isocyanurate, beta-hydroxy (alkyl) amides, alkylated carbamates, (meth)acrylates, isocyanates, blocked isocyanates, polyacids, anhydrides, organometallic acid-functional materials, polyamines, polyamides, aminoplasts, carbodiimides, oxazolines, tetrakis(methoxymethyl)glycoluril, and combinations thereof.

Any particular crosslinker or any combination of crosslinkers may be present in the coating composition in an amount of as little as 0.1 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 15 wt. %, 20 wt. %, 25 wt. % or in an amount as great as 50 wt. %, 45 wt. %, 40 wt. %, 35 wt. %, 30 wt. %, or any range including two of these values as endpoints based on the total weight of the coating composition. Any crosslinker or combination of crosslinkers may be present in an amount from 0.5 wt. % to 10 wt. %, from 0.5 wt. % to 8 wt. %, from 0.5 wt. % to 6 wt. %, from 0.5 wt. % to 5 wt. %, from 1 wt. % to 5 wt. %, from 1 wt. % to 4 wt. %, or from 1 wt. % to 2 wt. % based on the total weight of the coating composition or based on the weight of one component of the coating composition.

### V. Zinc

The coating compositions of the present disclosure may include zinc metal to improve its anti-corrosion and weatherability properties. The zinc metal may be in several forms such as dust, powder, particles, flakes, or combinations thereof. In this disclosure, the term “form” relates to zinc metal present in different morphologies, including but not limited to particulate or substantially cylindrical, flake or flake-like, substantially planar, and other different shapes.

The term “zinc powder” as used herein is used interchangeably with the term “zinc dust” and refers to pulverized metallic zinc in granular or substantially spherical form. Zinc powder is an effective and low-cost galvanized metal replacement. Its relatively larger particle size permits excellent topcoat adhesion whereas galvanizing generally requires pretreatment such as acid etching or wash primers to provide adequate adhesion. The zinc powder's average particle size may be as little as 0 microns, 1 micron, 2 microns, 3 microns, 4 microns, 4.5 microns, 5 microns, 6 microns, 7 microns, 8 microns, 9 microns, 10 microns, 15 microns, 20 microns, or as great as 50 microns, 45 microns, 40 microns, 35 microns, 30 microns, 25 microns, or any range including any two of these values as endpoints. The average particle size for the zinc powder may be from 4.5 to 8 microns. Suitable zinc powder is available from Purity Zinc Co., the Zinc Corporation of America (ZCA), or U.S. Zinc.

The term “zinc flakes” as used herein relates to zinc particulates that are substantially planar or fibrous in shape with an aspect ratio of width to thickness of as little as 1:1, 2:1, 3:1, 4:1, 5:1, 6:1, 7:1, 8:1, 9:1, 10:1, 15:1, or as great as 20:1, 25:1, 30:1, 35:1, 40:1, 45:1, 50:1, or any range including any two of these values as endpoints. Using zinc flakes in combination with zinc dust in the coating film provides more points of contact between the individual zinc flake and zinc dust particles. This increased contact promotes sacrificial corrosion of the zinc particles which may slow the corrosion of the underlying substrate. Zinc flakes having an average particle size of about 0.9 microns wide and 10 microns long are sold by Benda-Lutz of Sun Chemical Group.

The coating compositions may comprise several forms of zinc metal, such as zinc dust and zinc flake. The zinc dust may be present in the coating composition in an amount as little as 1 wt. %, 5 wt. %, 10 wt. %, 15 wt. %, 20 wt. %, or as great at 50 wt. %, 45 wt. %, 40 wt. %, 30 wt. %, or any range including any two of these values as endpoints based on the total weight of the coating composition. The zinc flake may be present in the coating composition in an amount little as 1 wt. %, 5 wt. %, 10 wt. %, 15 wt. %, 20 wt. %, or as great at 50 wt. %, 45 wt. %, 40 wt. %, 30 wt. %, or any range including any two of these values as endpoints based on the total weight of the coating composition. The total zinc content of the coating compositions which may include a combination of several forms of zinc may be as little as 20 wt. %, 25 wt. %, 30 wt. % or as great as 50 wt. %, 45 wt. %, 40 wt. %, or any range including any two of these values as endpoints based on the total weight of the coating composition.

### VI. Additives

The coating powder composition may further optionally comprise one or more additives known in the art. Such additives may include flow control agents, flow restricting agents, dry flow agents, antioxidants, pigments, colorants, optical brighteners, extenders, surface control agents, waxes, catalysts, reaction inhibitors, corrosion-inhibitors, conductivity enhances, and combinations comprising at least one of the foregoing additives, and the like.

The overcoat may also comprise a colorant. As used herein, “colorant” refers to any substance that imparts color and/or other opacity and/or other visual effect to the composition. The colorant may be added to the coating in any suitable form, such as discrete particles, dispersions, solutions, and/or flakes. A single colorant or a mixture of two or more colorants may be used in the coatings of the present disclosure.

Colorants include pigments (organic or inorganic), dyes and tints, such as those used in the paint industry and/or listed in the Dry Color Manufacturers Association (DCMA), as well as special effect compositions. A colorant may include a finely divided solid powder that is insoluble, but wettable, under the conditions of use. A colorant may be organic or inorganic and may be agglomerated or non-agglomerated. Colorants may be incorporated into the coatings by use of a grind vehicle, such as an acrylic grind vehicle, the use of which will be familiar to one skilled in the art.

Pigments and/or pigment compositions may include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and mixtures thereof.

Pigments may include, but are not limited to, those that are solvent and/or aqueous based such as phthalo green or blue, iron oxide, bismuth vanadate, anthraquinone, and peryleneand quinacridone.

The powder coating composition may further optionally comprise flow control agents, sometimes called leveling agents, which are useful to promote the formation of a continuous and even coating. Suitable flow control agents include polyacrylic esters, non-ionic fluorinated alkyl ester surfactants, non-ionic alkylarylpolyether alcohols, silicones, and the like, and combinations comprising at least one of the foregoing flow control agents. Flow control agents are generally liquids that have been converted to powder form by absorption onto silica-type materials. A preferred flow control agent is a 2-propenoic acid, ethyl ester polymer acrylic resin, available under the tradename RESIFLOW® P-67 by Estron Chemical, Inc.; a 2-hydroxy-1,2-diphenylethanone crystalline solid that is believed to keep the molten coating open for a suitable time to allow outgassing to occur prior to the formation of the hard-set film, sold under the tradename Benzoin by DSM, Inc. The powder coating composition may also include a dry flow agent such as fumed silica such as the ones sold under the tradename AEROSIL® by Evonik Corporation.

Any particular additive or any combination of additives may be present in the coating composition in an amount of as little as 0.1 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, or as great as 20 wt. %., 19 wt. %, 18 wt. %, 17 wt. %, 16 wt. %, 15 wt. %, 14 wt. %, 13 wt. %, 12 wt. %, or any range including any two of these values as endpoints based on the total weight of the coating composition. Any additive or combination of additives may be present in an amount from 0.5 wt. % to 10 wt. %, from 0.5 wt. % to 8 wt. %, from 0.5 wt. % to 6 wt. %, from 0.5 wt. % to 5 wt. %, from 1 wt. % to 5 wt. %, from 1 wt. % to 4 wt. %, or from 1 wt. % to 2 wt. % based on the total weight of the coating composition or based on the weight of one component of the coating composition.

### VII. Carbon Nanotubes

The coating compositions as described herein may also comprise single walled carbon nanotubes for improving the conductivity and edge corrosion performance of the coatings. Single wall carbon nanotubes are highly flexible and naturally aggregate to form ropes of elongated tubes. The formation of these ropes in the coating allows for high conductivity while keeping the carbon nanotube loading low. A preferred carbon nanotube additive is available under the trade name MATRIX 809 beta from Tuball™.

The carbon nanotubes may have an outer diameter of less than 5 nm, less than 4 nm, less than 3 nm, less than 2 nm, or less than 1 nm and a length of 1 micron, 2 microns, 3 microns, 4 microns, 5 microns, 6 microns, 7 microns, 8 microns, 9 microns, 10 microns, 11 microns, 12 microns, 13 microns, 14 microns, 15 microns, 16 microns, 17 microns, 18 microns, 19 microns, or 20 microns. The length to diameter ratio of the carbon nanotubes may be from 100:1-10,000:1.

Any particular carbon nanotube additive or any combination of carbon nanotube additives may be present in the coating composition in an amount of as little as 0.001 wt. %, 0.01 wt. %, 0.1 wt. %, 0.5 wt. %, 1 wt. %, 2 wt. %, wt. %, 4 wt. %, 5 wt. %, 6 wt. %, 7 wt. %, or as great as 8 wt. %, 9 wt. %, 10 wt. %, 15 wt. %, 20 wt. %, 25 wt. %, or any range including any two of these values as endpoints based on the total weight of the coating composition or based on the weight of one component of the coating composition. Any carbon nanotube additive or combination of carbon nanotube additives may be present in an amount from 0.5 wt. % to 10 wt. %, from 0.5 wt. % to 8 wt. %, from 0.5 wt. % to 6 wt. %, from 0.5 wt. % to 5 wt. %, from 1 wt. % to 5 wt. %, from 1 wt. % to 4 wt. %, or from 1 wt. % to 2 wt. % based on the total weight of the coating composition or based on the weight of one component of the coating composition.

### VIII. Substrates

The present disclosure relates to contacting at least a portion of a substrate with multi-component powder coating composition and curing the composition to form a coating layer.

The substrate according to the present disclosure can be selected from a wide variety of substrates and combinations thereof. Substrates may include vehicles and automotive substrates, industrial substrates, marine substrates and components such as ships, vessels, and on-shore and off-shore installations, storage tanks, packaging substrates, aerospace components, wood flooring and furniture, fasteners, coiled metals, heat exchangers, vents, an extrusion, roofing, wheels, grates, belts, conveyors, grain or seed silos, wire mesh, bolts or nuts, a screen or grid, HVAC equipment, frames, tanks cords, wires, apparel, electronic components, including housings and circuit boards, glass, sports equipment, including golf balls, stadiums, buildings, bridges, containers such as a food and beverage containers, and the like. As used herein, “vehicle” or variations thereof includes, but is not limited to, civilian, commercial and military aircraft, and/or land vehicles such as airplanes, helicopters, cars, motorcycles, and/or trucks. The shape of the substrate can be in the form of a sheet, plate, bar, rod or any shape desired.

The substrates, including any of the substrates previously described, can be metallic or non-metallic. Metallic substrates include, but are not limited to, tin, steel, cold rolled steel, hot rolled steel, steel coated with zinc metal, zinc compounds, zinc alloys, electrogalvanized steel, hot-dipped galvanized steel, galvannealed steel, galvalume, steel plated with zinc alloy, stainless steel, zinc-aluminum magnesium alloy coated steel, zinc-aluminum alloys, aluminum, aluminum alloys, aluminum plated steel, aluminum alloy plated steel, steel coated with a zinc-aluminum alloy, magnesium, magnesium alloys, nickel, nickel plating, bronze, tinplate, clad, titanium, brass, copper, silver, gold, 3-D printed metals, cast or forged metals and alloys, or combinations thereof.

Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (PET), polycarbonate, engineering polymers such as poly(etheretherketone) (PEEK), polycarbonate acrylobutadiene styrene (PC/ABS), polyamide, wood, veneer, wood composite, particle board, medium density fiberboard, cement, stone, glass, paper, cardboard, textiles, leather both synthetic and natural, composite substrates such as fiberglass composites or carbon fiber composites, 3-D printed polymers and composites, and the like.

### IX. Coating Methods

The components of the powder coating compositions may be contacted through mixing, grinding, or any suitable contacting method. The components may be a solid and more specifically may be a powder with an average particle size. The individual components may be contacted in any suitable ratio to form the coating composition.

FIG. 1 illustrates a cross sectional view of a substrate coated with the composition of the present application. Initially, the coating composition is applied to the substrate to form a cured layer.

The substrate may be preheated to a surface temperature or a bulk temperature before the application of the coating composition. The substrate may be heated to a surface temperature of as little as 100° F., 125° F., 150° F., 175° F., 200° F., or as great as 225° F., 250° F., 275° F., 300° F., 325° F., 350° F., 375° F., 400° F., or any range including any two of these values as endpoints. Stated differently, the substrate may be heated to a surface temperature of as little as 40° C., 50° C., 60° C., 70° C., 80° C., 90° C., 100° C., 110° C., or as great as 120° C., 130° C., 140° C., 150° C., 160° C., 170° C., 180° C., 190° C., 200° C., 210° C. or any range including any two of these values as endpoints. The substrate may be heated to a surface temperature from 40° C. to 150° C., from 50° C. to 150° C., from 60° C. to 150° C., from 70° C. to 150° C., from 80° C. to 150° C., from 90° C. to 150° C., from 100° C. to 150° C., from 110° C. to 150° C., from 110° C. to 140° C., or from 120° C. to 140° C.

Once the coating composition has been applied to the substrate, the coating is cured. The curable coating composition may be cured with heat, increased or reduced pressure, chemically such as with moisture, or with other means such as actinic radiation, and combinations thereof. Curing may comprise an initial curing step with radiation, followed by heating. The term “actinic radiation” refers to electromagnetic radiation that can initiate chemical reactions. Actinic radiation includes, but is not limited to, visible light, ultraviolet (UV) light, infrared (IR), X-ray, and gamma radiation.

The coating composition may be cured at a low temperature. The coating composition may be cured at less than 450° F., less than 425° F., less than 400° F., less than 375° F., less than 350° F., less than 325° F., less than 300° F., less than 290° F., less than 280° F., less than 275° F., less than 270° F., less than 260° F., less than 250 OF, or any range including any two of these values as endpoints. Stated differently, the coating composition may be cured at less than 240° C., less than 230° C., less than 220° C., less than 210° C., less than 200° C., less than 190° C., less than 180° C., less than 170° C., less than 160° C., less than 150° C., less than 140° C., less than 130° C., less than 120° C., or any range including any two of these values as endpoints. The coating composition may be cured at a temperature from 120° C. to 200° C., from 120° C. to 190° C., from 120° C. to 180° C., from 120° C. to 170° C., from 120° C. to 160° C., from 120° C. to 150° C., from 120° C. to 140° C., or from 120° C. to 130° C.

The curing step may be carried out for any suitable time to allow the coating to fully or at least partially cure. The curing time may vary depending on the substrate, the coating composition, the coating thickness, ambient conditions, curing methods, or any combination of these factors. Curing time may be as little as 1 minute, 2 minutes, 3 minutes, 4 minutes, 5 minutes, 6 minutes, 7 minutes, 8 minutes, 9 minutes, 10 minutes, or as great as 60 minutes, 55 minutes, 50 minutes, 45 minutes, 40 minutes, 35 minutes, 30 minutes, 25 minutes, 20 minutes, 15 minutes, 12 minutes, or any range including any two of these values as endpoints. The curing time may be from 1 minute to 30 minutes, from 1 minute to 20 minutes, from 1 minute to 15 minutes, from 1 minute to 10 minutes, from 1 minute to 6 minutes, from 5 minutes to 15 minutes, from 5 minutes to 10 minutes, or from 3 minutes to 9 minutes.

The overall coating on the substrate may have a thickness of as little as 0.1 mils, 0.2 mils, 0.3 mils, 0.4 mils, 0.5 mils, 0.6 mils, 0.7 mils, 0.8 mils, 0.9 mils, 1 mil, 1.5 mils, 2 mils, 2.5 mils or as great as 20 mils, 15 mils, 14 mils, 13 mils, 12 mils, 11 mils, 10 mils, 9 mils, 8 mils, 7 mils, 6 mils, 5 mils, 4 mils, 3.9 mils, 3.8 mils, 3.7 mils, 3.6 mils, 3.5 mils, 3.4 mils, 3.3 mils, 3.2 mils, 3.1 mils, 3 mils, or any range including any two of these amounts as endpoints. The overall coating may have a thickness of 1 mils to 4 mils, 1.5 mils to 2.5 mils, or 2 mils to 3 mils. The thickness may be measured according to the ASTM D7091-13 test method using and Elcometer 415 Model B Dual FNF film gauge.

Other application methods that can be used to apply the coating composition onto the substrate include: spraying, such as by incorporating the coating composition into a liquid formulation and using spray equipment; wiping where the coating composition is contained on and/or in a wipe and manually or automatically wiped; media blasting where the coating composition is a solid and is blasted onto the substrate's surface; electrostatically applied as a powder; brushing or rolling the coating composition over the substrate such as by incorporating the coating composition into a formulation (e.g., liquid or gel) that can be brushed or rolled; vapor deposition; electrodeposition where the formulation is liquid and is electro-coated; or any combination thereof. The coating composition may also be applied in-mold, during extrusion, during a calendaring, or during other processing of substrate materials.

The coating composition may be applied directly to a substrate without any intermediate layers between the coating composition and the substrate. The coating composition may be applied directly to a metal substrate, before or after the substrate is cleaned and/or treated as further described herein, but before application of any coating layers. The coating composition may also be applied during cleaning such as a component of the cleaner. The coating composition may be applied over the entire surface, edges, and corners of the substrate, or the coating composition may be applied over selected portions of the substrate.

The coating composition may also form a continuous or semi-continuous layer over the substrate, or the coating composition may be applied over certain spots/areas of the substrate such as the edges and corners of the substrate. As used herein, the area referred to as the “edge” will vary based on the particular substrate but may include, e.g., the outer most lateral face of the substrate.

The coating composition can be applied to the substrate to form a monocoat. As used herein, a “monocoat” refers to a single coating layer that is free of additional coating layers. Thus, the coating composition can be applied directly to a substrate and cured to form a single layer coating, i.e. a monocoat.

The coated substrate of the present disclosure may further comprise one or more additional coating layers, such as a second overcoat deposited onto at least a portion of the first coating composition, to form a multi-layer coating such as by applying a topcoat. When a multi-layer coating is formed, the first coating composition can be cured prior to application of additional overcoats, or one or more of the additional overcoats and the first coating composition can be cured simultaneously. It is appreciated that the second overcoat and additional overcoat can be in solid or liquid form. The coating compositions may be layered underneath a topcoat or series of topcoats to form a stackup.

### X. Coated Substrate Properties

Substrates coated according to the present disclosure may have one or more improved properties and may address one or more issues known in the coating industry. The improved properties may be observed in comparison to other, previously known coating compositions.

The present coating composition may be cured at less than 450° F., less than 425° F., less than 400° F., less than 375° F., less than 350° F., less than 325° F., less than 300° F., less than 290° F., less than 280° F., less than 275° F., less than 270° F., less than 260° F., less than 250° F., or any range including any two of these values as endpoints. Stated differently, the coating composition may be cured at less than 240° C., less than 230° C., less than 220° C., less than 210° C., less than 200° C., less than 190° C., less than 180° C., less than 170° C., less than 160° C., less than 150° C., less than 140° C., less than 130° C., less than 120° C., or any range including any two of these values as endpoints. The coating composition may be cured at a temperature from 120° C. to 200° C., from 120° C. to 190° C., from 120° C. to 180° C., from 120° C. to 170° C., from 120° C. to 160° C., from 120° C. to 150° C., from 120° C. to 140° C., or from 120° C. to 130° C.

The present coating compositions may be resistant to corrosion as measured by a salt spraying test according to the methods set forth in ASTM B117-19. The present coating composition when applied to a substrate may demonstrate less than 5 mm average scribe creepage after at least 100 hours, at least 200 hours, at least 300 hours, at least 400 hours, at least 500 hours, at least 600 hours, at least 700 hours, at least 800 hours, at least 1000 hours, at least 1500 hours, at least 2000 hours, at least 2500 hours, at least 3000 hours, at least 3500 hours, at least 4000 hours, at least 4500 hours, at least 5000 hours.

The present coating compositions may have a low surface resistivity as measured by ANSI/ESD STM 4.1-2017. The present coating compositions when applied to a substrate may demonstrate a surface resistivity of as little as 100 ohms/square, 200 ohms/square, 300 ohms/square, 400 ohms/square, 500 ohms/square, 600 ohms/square, 700 ohms/square, 800 ohms/square, 900 ohms/square, 1000 ohms/square, 2000 ohms/square, 3000 ohms/square, 4000 ohms/square, 5000 ohms/square, 6000 ohms/square, 7000 ohms/square, 8000 ohms/square, 9000 ohms/square, 10,000 ohms/square, or as great as 50,000 ohms/square, 100,000 ohms/square, 500,000 ohms/square, 1,000,000 ohms/square, 10,000,000 ohms/square or any range including any two of these values as endpoints. The coating composition may have a surface resistivity of from 100 ohms/square to 1,000,000 ohms/square, from 200 ohms/square to 500,000 ohms/square, from 300 ohms/square to 100,000 ohms/square, from 400 ohms/square to 50,000 ohms/square, or from 500 ohms/square to 10,000 ohms/square.

### EXAMPLES

### Example 1

### Preparation of Curable Coating Compositions

Four curable coating compositions were prepared from the components listed in Table 1.

TABLE 1
Mass breakdown of curable coating compositions.

| | | Ex. | Ex. | Ex. | Ex. | Ex. | Ex. |
|---|---|---|---|---|---|---|---|
| | | 1 | 2 | 3 | 4 | 5 | 6 |
| | | (wt. | (wt. | (wt. | (wt. | (wt. | (wt. |
| Component | Further Info | %) | %) | %) | %) | %) | %) |
| Film forming | Reafree 5700 | 48.1 | — | — | — | — | — |
| resin | Polyester resin based on | | | | | | |
| | isophthalic acid with acid | | | | | | |
| | value of 32-38. Available | | | | | | |
| | from Arkema | | | | | | |
| Crosslinker | Lunamer 552 | 2.5 | 1.6 | 1.7 | 1.7 | 1.5 | — |
| | Hydroxyalkylamide | | | | | | |
| | crosslinker, commercially | | | | | | |
| | available from DKSH. | | | | | | |
| Flow agent | Resiflow PL-200A | 0.9 | 0.9 | 0.9 | 0.9 | 0.9 | 0.2 |
| | Acrylic/silica flow and | | | | | | |
| | leveling control agent, | | | | | | |
| | commercially available | | | | | | |
| | from Estron Chemical. | | | | | | |
| Degassing | Benzoin Degassing/ | 0.5 | 0.5 | 0.5 | 0.5 | 0.5 | 0.1 |
| agent | debubbling agent, | | | | | | |
| | commercially available | | | | | | |
| | from Mitsubishi Chemical | | | | | | |
| Corrosion | #2 Zinc Dust/330LL | 48.0 | 45.8 | 48.0 | 33.5 | 33.5 | 33.5 |
| inhibiting | Zinc dust powder, | | | | | | |
| agent | commercially available | | | | | | |
| | from U.S. Zinc. | | | | | | |
| Film forming | Uralac P3480 | — | 47.7 | 48.7 | 48.8 | 44.0 | — |
| resin | Polyester resin based on | | | | | | |
| | isophthalic acid with | | | | | | |
| | an acid value of 20-25, | | | | | | |
| | commercially | | | | | | |
| | available from Covestro. | | | | | | |
| Copolymer | Licocene PE MA 4351 | — | 0.5 | — | — | — | — |
| | Ethylene-maleic anhydride | | | | | | |
| | copolymer, commercially | | | | | | |
| | available from Clairant. | | | | | | |
| Pigment | Tronox CR-880 | — | 2.5 | — | — | — | — |
| | Titanium dioxide pigment, | | | | | | |
| | commercially available | | | | | | |
| | from Tronox. | | | | | | |
| Flow | Bentone 34 | — | 0.5 | — | — | — | — |
| restricting | Organic derivative of a | | | | | | |
| agent | bentonite clay, | | | | | | |
| | commercially available | | | | | | |
| | from Elementis. | | | | | | |
| Carbon | Tuball Matrix Beta 809 | — | — | 0.2 | 0.2 | 0.2 | 0.2 |
| nanotubes | Single wall carbon | | | | | | |
| | nanotubes in a | | | | | | |
| | polyethylene wax carrier, | | | | | | |
| | commercially available | | | | | | |
| | form OCSiAl. | | | | | | |
| Corrosion | Z-2031 Zinc Flake | — | — | — | 14.4 | 14.4 | 14.3 |
| inhibiting | Zinc flakes, commercially | | | | | | |
| agent | available from | | | | | | |
| | Sun Chemical. | | | | | | |
| Film forming | Epiclon TSR-400 | — | — | — | — | 5.0 | — |
| resin | Isocyanate modified epoxy | | | | | | |
| | resin, commercially | | | | | | |
| | available from | | | | | | |
| | DIC Corporation. | | | | | | |
| Film forming | Epon Resin 2004 | — | — | — | — | — | 26.5 |
| resin | Epoxy resin, commercially | | | | | | |
| | available from Hexion | | | | | | |
| Film forming | YD-017 | — | — | — | — | — | 16.1 |
| resin | Epoxy resin, commercially | | | | | | |
| | available from Kukdo | | | | | | |
| | Chemical. | | | | | | |
| Curing agent | KD-404J | — | — | — | — | — | 9.1 |
| | Phenol excess type curing | | | | | | |
| | agent, commercially | | | | | | |
| | available from | | | | | | |
| | Kukdo Chemical | | | | | | |

Each of the components listed in Table 1 for Examples 1-6 were weighed in a plastic bag and mixed by shaking vigorously in the same plastic bag for 30 seconds to form a dry homogeneous mixture. The mixture was melt mixed in a Theysohn 30 mm twin screw extruder with a moderately aggressive screw configuration and a speed of 500 RPM. The first extruder zone was set at 50° C., and the second zone was set to 100° C. The feed rate was such that a torque of 30-35% was observed on the equipment. The mixtures were dropped onto a set of chill rolls to cool and re-solidify the mixtures into solid chips. The chips were milled using a coffee grinder and sieved through a 104 micron screen to obtain a median diameter particle size of 35-40 microns. The resulting coating compositions for each of Examples 1-6 were solid particulate powder coating compositions that were free flowing.

### Example 2

### Application and Testing of Curable Coating Compositions

The coating compositions of Example 1 were subjected to a coating thickness test, a resistivity test, and a salt spray resistance test. The resulting properties are set forth in Table 2 below.

TABLE 2
Performance of curable coating compositions

| Physical | Testing | | | | Ex. | Ex. | Ex. |
|---|---|---|---|---|---|---|---|
| Property | Standard | Ex. 1 | Ex. 2 | Ex. 3 | 4 | 5 | 6 |
| Coating | ASTM | 2-3 | 2-3 | 2-3 | 2-3 | 2-3 | 2-3 |
| Thickness | D7091-13 test | | | | | | |
| (mils) | method using | | | | | | |
| | Elcometer | | | | | | |
| | 415 Model B | | | | | | |
| | Dual FNF | | | | | | |
| Resistivity | ANSI/ESD | 10000- | 100000- | 1000- | 10000- | 1000- | 1000- |
| (ohms/square) | STM4.1-2017 | 100000 | 1000000 | 10000 | 100000 | 10000 | 10000 |
| to Groundable | using Static | | | | | | |
| Point | Solutions, Inc. | | | | | | |
| | Ohm-Stat RT- | | | | | | |
| | 1000 | | | | | | |
| Salt Spray | ASTM B117- | 3-5 | 3-5 | 1-2 | 0-0.5 | | |
| Resistance- | 19 for salt | | | | | | |
| Average Scribe | spray cabinet | | | | | | |
| Creepage (mm) | operation and | | | | | | |
| after 3000 | ASTM D1654 | | | | | | |
| hours | for | | | | | | |
| | evaluations | | | | | | |
| Salt Spray | ASTM B117- | | | 2-3 | 0.5-1.0 | | |
| Resistance- | 19 for salt | | | | | | |
| Average Scribe | spray cabinet | | | | | | |
| Creepage (mm) | operation and | | | | | | |
| after 4000 | ASTM D1654 | | | | | | |
| hours | for | | | | | | |
| | evaluations | | | | | | |

All powder coating compositions from Examples 1-6 were applied over several iron phosphate pretreated 0.032 inch by 3 inch by 6 inch cold-rolled steel panels at film thicknesses shown in Table 1 and baked for 15 minutes at 350° F. The tests described in the lower portion of Table 1 were performed on these coated panels. The panels intended for salt spray testing were top coated with 2 to 3 mils of a white polyester TGIC powder coating before placing on salt spray testing.

1. A powder coating composition comprising:
zinc metal in an amount from 20 wt. % to 50 wt. % based on a total weight of the coating composition, the zinc metal present in at least two physical forms; and
a film forming resin in an amount from 35 wt. % to 80 wt. % based on a total weight of the coating composition.

2. The powder coating composition of claim 1, wherein the film forming resin is a saturated, carboxylated polyester resin.

3. The powder coating composition of claim 1, wherein the film forming resin is a hydroxylated polyester resin.

4. The powder coating composition of claim 2, wherein the composition further comprises from 0.1 wt. % to 10 wt. % of an isocyanate modified epoxy resin.

5. The powder coating composition of claim 1, wherein the film forming resin is an epoxy resin.

6. The powder coating composition of claim 1, wherein the composition further comprises a crosslinking agent.

7. The powder coating composition of claim 6, wherein the crosslinking agent is selected from beta hydroxyalkyl amides, triglycidyl isocyanurates, acrylics, isocyanates, tetrakis(methoxymethyl)glycoluril, phenolic resins, dicyandiamides, carboxylated polyesters, epoxies, and combinations of the foregoing.

8. The powder coating composition of claim 1, wherein the composition further comprises carbon nanotubes in an amount from 0.001 wt. % to 2 wt. % based on a total weight of the coating composition.

9. The powder coating composition of claim 1, wherein the composition further comprises at least one of a flow agent, a degassing agent, and an anti-caking agent.

10. The powder coating composition of claim 1, wherein the zinc metal comprises zinc flakes and zinc particles.

11. The powder coating primer composition of claim 10, wherein the zinc flakes are in an amount from 1 wt. % to 50 wt. % based on a total weight of the coating composition.

12. A substrate coated with the composition of claim 1.

13. The substrate of claim 12, wherein the coating composition has at least one of the following properties:
(i) a surface resistivity of from 100 to 10,000,000 ohms/sq as measured according to ANSI/ESD STM4.1-2017;
(ii) less than 3 mm average scribe creepage after 3000 hours of salt spray according to ASTM B117-19; and
(iii) less than 5 mm average scribe creepage after 4000 hours of salt spray according to ASTM B117-19.

14. A substrate coated with a powder coating composition comprising:
zinc metal in an amount from 20 wt. % to 50 wt. % based on a total weight of the coating composition, the zinc metal present in at least two physical forms; and
a film forming resin in an amount from 35 wt. % to 80 wt. % based on a total weight of the coating composition.

15. The coated substrate of any of claim 13, wherein the coating comprises a film forming resin in an amount of from 35 wt. % to 80 wt. % based on a total weight of the coating composition.

16. The coated substrate of claim 13, wherein the coating comprises a carboxylated polyester resin in an amount of from 30 wt. % to 80 wt. % based on a total weight of the coating composition.

17. The coated substrate of claim 1, wherein the coating comprises an epoxy resin in an amount of from 30 wt. % to 80 wt. % based on a total weight of the coating composition.

18. The coated substrate of claim 13, wherein the coating comprises 2 or more layers.

19. The coated substrate of claim 13, wherein the coating has a thickness of from 2 to 20 mils.

20. The coated substrate of claim 13, wherein the coating composition has at least one of the following properties:
(i) a surface resistivity of from 100 to 10,000,000 ohms/sq as measured according to ANSI/ESD STM4.1-2017;
(ii) less than 3 mm average scribe creepage after 3000 hours of salt spray according to ASTM B117-19; and
(iii) less than 5 mm average scribe creepage after 4000 hours of salt spray according to ASTM B117-19.
